(19) United States
(12) Patent Application Publication
(10) Pub. No.: US 2025/0342143 A1
(43) Pub. Date: Nov. 6, 2025

(54) TRANSACTION EXECUTION METHODS AND BLOCKCHAIN NODES IN BLOCKCHAIN SYSTEMS

(71) Applicant: Ant Blockchain Technology (Shanghai) Co., Ltd., Shanghai (CN)

(72) Inventors: Shenglong Chen, Hangzhou (CN); Zhiyuan Zhou, Hangzhou (CN)

(73) Assignee: Ant Blockchain Technology (Shanghai) Co., Ltd., Shanghai (CN)

(21) Appl. No.: 19/271,153

(22) Filed: Jul. 16, 2025

Related U.S. Application Data
(63) Continuation of application No. PCT/CN2023/135029, filed on Nov. 29, 2023.

(30) Foreign Application Priority Data
Apr. 28, 2023 (CN) 202310493508.9

(51) Int. Cl. G06F 16/22

(52) U.S. Cl. CPC G06F 16/2255

(57) ABSTRACT

Transaction execution methods and blockchain nodes in blockchain systems are provided. In an implementation, a controller process of a blockchain node obtains a plurality of analysis results of a plurality of transactions from a plurality of txpool processes of the blockchain node. The analysis result includes a transaction hash, read/write information, and indication information of a first transaction corresponding to the analysis result. The controller process further divides the plurality of analysis results into a plurality of data groups based on read/write information included in each of the plurality of analysis results, and distribute the plurality of data groups to a plurality of compute processes of the blockchain node.

### CROSS-REFERENCE TO RELATED APPLICATIONS

This application is a continuation of PCT Application No. PCT/CN2023/135029, filed on Nov. 29, 2023, which claims priority to Chinese Patent Application No. 202310493508.9, filed on Apr. 28, 2023, and each application is hereby incorporated by reference in its entirety.

### TECHNICAL FIELD

Embodiments of this specification pertain to the blockchain field, and in particular, to transaction execution methods and blockchain nodes in blockchain systems.

### BACKGROUND

Blockchain is a novel application model of computer technologies such as distributed data storage, peer-to-peer transmission, consensus mechanisms, and encryption algorithms. In a blockchain system, data blocks are sequentially organized into a chain data structure in chronological order, and a distributed ledger is cryptographically ensured to be tamper-proof and unforgeable. Due to characteristics such as decentralization, tamper-proof information, and autonomy, the blockchain has received increasing attention and applications.

### SUMMARY

This application aims to provide transaction execution methods and blockchain nodes in blockchain systems.

According to a first aspect, a transaction execution method in a blockchain system is provided. The method is performed by a blockchain node in the blockchain system, the blockchain node includes a controller process, a plurality of txpool processes, and a plurality of compute processes. The method includes: The controller process obtains a plurality of analysis results of a plurality of first transactions from the plurality of txpool processes. The analysis result includes a transaction hash, read/write information, and indication information of a first transaction corresponding to the analysis result. The controller process divides the plurality of analysis results into a plurality of data groups based on read/write information included in each of the plurality of analysis results, and distributes the plurality of data groups to the plurality of compute processes. For an i^{th} analysis result in a data group received by the compute process, the compute process determines, based on indication information included in the i^{th} analysis result, a first txpool process for managing a first transaction corresponding to the i^{th} analysis result, obtains, from the first txpool process based on a transaction hash included in the i^{th} analysis result, the first transaction corresponding to the i^{th} analysis result, and executes the first transaction corresponding to the i^{th} analysis result.

According to a second aspect, a blockchain node in a blockchain system is provided. The blockchain node includes a controller process, a plurality of txpool processes, and a plurality of compute processes. The controller process is configured to obtain a plurality of analysis results of a plurality of first transactions from the plurality of txpool processes. The analysis result includes a transaction hash, read/write information, and indication information of a first transaction corresponding to the analysis result. The controller process is further configured to divide the plurality of analysis results into a plurality of data groups based on read/write information included in each of the plurality of analysis results, and distribute the plurality of data groups to the plurality of compute processes. The compute process is configured to: for an i^{th} analysis result in a data group received by the compute process, determine, based on indication information included in the i^{th} analysis result, a first txpool process for managing a first transaction corresponding to the i^{th} analysis result, obtain, from the first txpool process based on a transaction hash included in the i^{th} analysis result, the first transaction corresponding to the i^{th} analysis result, and execute the first transaction corresponding to the i^{th} analysis result.

In the solutions of the embodiments of this specification, a blockchain node includes at least a controller process, a plurality of txpool processes, and a plurality of compute processes. The controller process can obtain a plurality of analysis results of a plurality of first transactions from the plurality of txpool processes. The analysis result includes a transaction hash, read/write information, and indication information of a first transaction corresponding to the analysis result. The controller process can further divide the plurality of analysis results into a plurality of data groups based on read/write information included in each of the plurality of analysis results, and distribute the plurality of data groups to the plurality of compute processes. Correspondingly, for an i^{th} analysis result in a data group received by the compute process, the compute process can determine, based on indication information included in the i^{th} analysis result, a first txpool process for managing a first transaction corresponding to the i^{th} analysis result, obtain, from the first txpool process based on a transaction hash included in the i^{th} analysis result, the first transaction corresponding to the i^{th} analysis result, and execute the first transaction corresponding to the i^{th} analysis result. As such, the controller process that only supports running as a single instance does not execute transactions related to transaction plaintexts, but the plurality of txpool processes running concurrently are responsible for managing the transaction plaintexts and providing analysis results of the transactions, so that a control flow and a data flow can be decoupled for the controller process to a greater extent, thereby reducing transactions that need to be implemented by the controller process, and helping improve performance of the blockchain system.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is an architectural diagram illustrating a blockchain system, according to one or more embodiments of this specification;

FIG. 2 is a first schematic structural diagram illustrating a blockchain node in a blockchain system, according to one or more embodiments of this specification;

FIG. 3 is a flowchart illustrating a transaction processing method in a blockchain system, according to one or more embodiments of this specification;

FIG. 4 is a flowchart illustrating a transaction execution method in a blockchain system, according to one or more embodiments of this specification; and

FIG. 5 is a schematic structural diagram illustrating a blockchain node in a blockchain system, according to one or more embodiments of this specification.

### DESCRIPTION OF EMBODIMENTS

To enable a person skilled in the art to better understand the technical solutions in this specification, the technical solutions in the embodiments of this specification will be clearly and comprehensively described in combination with the accompanying drawings in the embodiments of this specification. It is clear that the described embodiments are only some embodiments of this specification, not all embodiments. All other embodiments obtained by a person of ordinary skill in the art based on the embodiments of this specification without creative efforts shall fall within the protection scope of this specification.

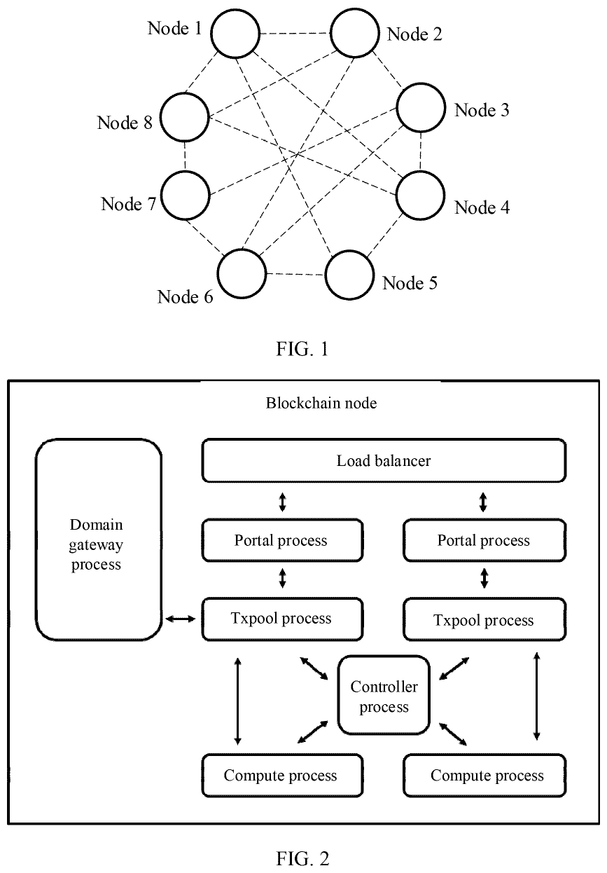

FIG. 1 is an example architectural diagram illustrating a blockchain system, according to one or more embodiments of this specification. The blockchain system can include N blockchain nodes. For example, FIG. 1 shows eight blockchain nodes: a node 1 to a node 8. A connection line between nodes is shown as a schematic representation of a peer-to-peer (P2P) connection. The connection can be, for example, a transmission control protocol (TCP) connection, and the connection is used to support data transmission between different nodes.

System data that need to be persistently stored in the blockchain system can be divided into two parts: block data and status data.

The block data includes one or more blocks incremented by a block height (or referred to as a block number), and a single block can include a block head and a block body. The block header can include a previous block's block hash previous_Hash (or referred to as a parent hash), a timestamp, a block number BlockNum, a state root hash State_Root, a transaction root hash Transaction_Root, a receipt root hash Receipt_Root, and the like. The block body can include a transaction set and a receipt set.

A transaction in the blockchain system is a task unit executed and recorded in the blockchain system. A single transaction usually includes a sender field (From), a receiver field (To), and a data field (Data). The field From includes an account that initiates the transaction. The field To may include another account that the transaction relates/points to.

For a k^{th} block, a plurality of sequenced transactions included in a transaction set belonging to the k^{th} block can be executed based on status data whose block height (or version) is k−1, to obtain execution results of the plurality of transactions. Then, the status data whose block height is k−1 is updated based on the execution results of the plurality of transactions, to obtain status data whose block height is k.

The embodiments of this specification provide at least transaction execution methods in blockchain systems and blockchain systems. The blockchain node includes at least a controller process, a plurality of txpool processes, and a plurality of compute processes. The controller process can obtain a plurality of analysis results of a plurality of first transactions from the plurality of txpool processes. The analysis result includes a transaction hash, read/write information, and indication information of a first transaction corresponding to the analysis result. The controller process can further divide the plurality of analysis results into a plurality of data groups based on read/write information included in each of the plurality of analysis results, and distribute the plurality of data groups to the plurality of compute processes. Correspondingly, for an i^{th} analysis result in a data group received by the compute process, the compute process can determine, based on indication information included in the i^{th} analysis result, a first txpool process for managing a first transaction corresponding to the i^{th} analysis result, obtain, from the first txpool process based on a transaction hash included in the i^{th} analysis result, the first transaction corresponding to the i^{th} analysis result, and execute the first transaction corresponding to the i^{th} analysis result. As such, the controller process that only supports running as a single instance does not execute transactions related to transaction plaintexts, but the plurality of txpool processes running concurrently are responsible for managing the transaction plaintexts and providing analysis results of the transactions, so that a control flow and a data flow can be decoupled for the controller process to a greater extent, thereby reducing transactions that need to be implemented by the controller process, and helping improve performance of the blockchain system.

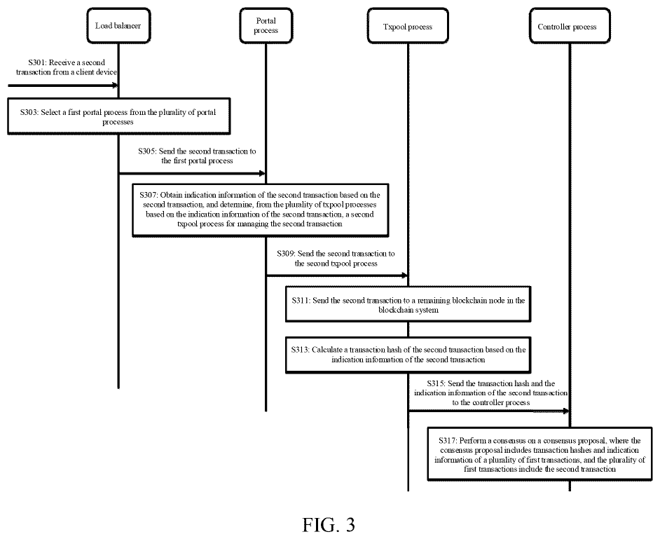

FIG. 2 is a first schematic structural diagram illustrating a blockchain node in a blockchain system, according to one or more embodiments of this specification. With reference to FIG. 2, the blockchain node includes at least a controller process, a plurality of txpool processes (which may also be described as a transaction cache pool process), and a plurality of compute processes. The blockchain node can further include one or more of a load balancer, one or more portal processes, a domain gateway process responsible for communication between nodes, or a storage process. The domain gateway process corresponds to a P2P service/module of the blockchain node. The one or more portal processes are mainly responsible for information exchange with a client device. The domain gateway process is mainly responsible for information exchange with a remaining blockchain node in the blockchain system. Notably, the process is a data set-related running activity of a program that has an independent function in a computer application, that is, a process in a computer that is performed by sequentially executing instructions in an application program by a processor, and each process is allocated its own memory address space when being created. A plurality of processes in a single blockchain node can be a plurality of processes in a plurality of computing devices or virtual computing nodes.

FIG. 3 is a flowchart illustrating a transaction processing method in a blockchain system, according to one or more embodiments of this specification. The method can be performed by a blockchain node in the blockchain system, for example, the blockchain node illustrated in FIG. 2. The method illustrates a process in which a second transaction sent by a client device is sent to a txpool process in the blockchain node, and the blockchain node initiates, based on the second transaction, a consensus on a consensus proposal corresponding to a target block to be generated.

With reference to FIG. 3, the method can include but is not limited to some or all of the following step S301 to step S317.

When the blockchain node is configured with a load balancer and a plurality of portal processes, the blockchain node may receive, from the client device, the second transaction to be executed. In this case, the blockchain node may perform the following step S301 to step S307.

Step S301: The load balancer receives the second transaction from the client device.

Step S303: The load balancer selects a first portal process from the plurality of portal processes.

The load balancer can schedule, based on load conditions of the plurality of portal processes, the second transaction received by the load balancer. To be specific, after receiving the second transaction, the load balancer can select a portal process currently with low load as the first portal process.

Step S305: The load balancer sends the second transaction to the first portal process.

Step S307: The first portal process obtains indication information of the second transaction based on the second transaction, and determines, from a plurality of txpool processes based on the indication information of the second transaction, a second txpool process for managing the second transaction.

The indication information of the second transaction can include an account that initiates the second transaction. Alternatively, the indication information of the second transaction can be obtained through processing based on the account that initiates the second transaction, for example, is the first byte of the account that initiates the second transaction.

One or more pieces of indication information corresponding to each of the plurality of txpool processes can be maintained by using prestored configuration information. After receiving the second transaction, the first portal process can extract the first byte of the account included in a field From of the second transaction (which may be described as the first byte of a sender of the transaction) as the indication information of the transaction, and then query the prestored configuration information based on the indication information of the transaction, to determine a corresponding second txpool process from the plurality of txpool processes.

Step S309: The first portal process sends the second transaction to the second txpool process.

When the blockchain node is configured with no load balancer and only a single portal process, the blockchain node may not perform step S301 to step S309, but directly uses the single portal process configured in the blockchain node to receive the second transaction from the client device, and perform the functions implemented by the first portal process in step S307 and step S309.

After receiving the second transaction from the client device, the second txpool process can perform pre-verification on the second transaction, including verification on a signature, a transaction format, and the like of the second transaction, as well as whether the account that initiates the second transaction has sufficient gas or the like. After the second transaction is verified, the second txpool process can continue to perform step S311 to send the second transaction to a remaining blockchain node in the blockchain system.

The second txpool process can broadcast the second transaction to the remaining blockchain node by invoking a domain gateway process. Corresponding to step S311, a txpool process in the remaining blockchain node in the blockchain node may receive, from the current blockchain node, the second transaction received by the current blockchain node from the client device. Therefore, the current blockchain node may not receive the second transaction directly from the client device, but receives, from a remaining blockchain node, the second transaction sent by the client device. In this case, for example, the blockchain node can receive the second transaction from the remaining blockchain node via the domain gateway process, and the domain gateway process implements the functions implemented by the first portal process in step S307 and step S309.

Regardless of whether the second transaction comes from the client device or the remaining blockchain node, the second txpool process that receives the second transaction can perform step S313 on the second transaction to obtain indication information of the second transaction based on the second transaction and calculate a transaction hash of the second transaction, and perform step S315 to send the transaction hash and the indication information of the second transaction to a controller process.

The second txpool process can invoke the controller process based on a specific algorithm, to send the transaction hash and the indication information of the second transaction received by the second txpool process to the controller process. For example, after receiving the second transaction, the second txpool process immediately performs step S313 and step S315, or may perform, periodically based on a predetermined time interval, step S313 and step S315 on each second transaction received within a current time interval.

The transaction hash may be a hash value of the second transaction, or may be a short hash obtained based on the hash value of the second transaction.

The controller process can initiate, based on a corresponding policy by using transaction hashes and indication information of second transactions from the plurality of txpool processes, the consensus proposal corresponding to the target block to be generated.

Specifically, in step S317, the controller process performs a consensus on the consensus proposal, where the consensus proposal includes transaction hashes and indication information of a plurality of first transactions, and the plurality of first transactions include the second transaction.

More specifically, the controller process may receive transaction hashes and indication information of a plurality of second transactions from the plurality of txpool processes, and then can correspondingly select transaction hashes and indication information of some or all second transactions from the transaction hashes and the indication information of the plurality of second transactions as the transaction hashes and the indication information of the plurality of first transactions, to generate the consensus proposal corresponding to the target block.

A consensus module in the controller process can generate, by using a consensus algorithm such as PBFT or MYPBFT, a consensus proposal corresponding to a target block to be generated, and perform a consensus on the consensus proposal with the remaining blockchain node in the blockchain system. The consensus proposal can specifically include a transaction hash list (tx list hash) that includes the transaction hashes of the plurality of first transactions in sequence, and an indication information list that includes the indication information of the plurality of first transactions in sequence. In a consensus process of the consensus proposal, after receiving a preprepare message, for a transaction hash and indication information of a single first transaction, the consensus module of the controller process can notify, based on the indication information and the transaction hash of the first transaction, a corresponding txpool process to check existence of the first transaction. If existent, the related first transaction is persisted by the corresponding txpool process. Otherwise, the blockchain node can exit the consensus process or provide information indicating that the blockchain node does not agree with the consensus proposal.

The method shown in FIG. 3 is merely an example. The txpool process in the blockchain node may use another way to obtain the second transaction from the client device, and use another way to obtain the consensus proposal based on the plurality of first transactions and perform a consensus on the consensus proposal.

When a consensus is reached on the consensus proposal based on the plurality of first transactions, the blockchain node can execute the plurality of first transactions through cooperation of the controller process, the plurality of txpool processes, and the plurality of compute processes.

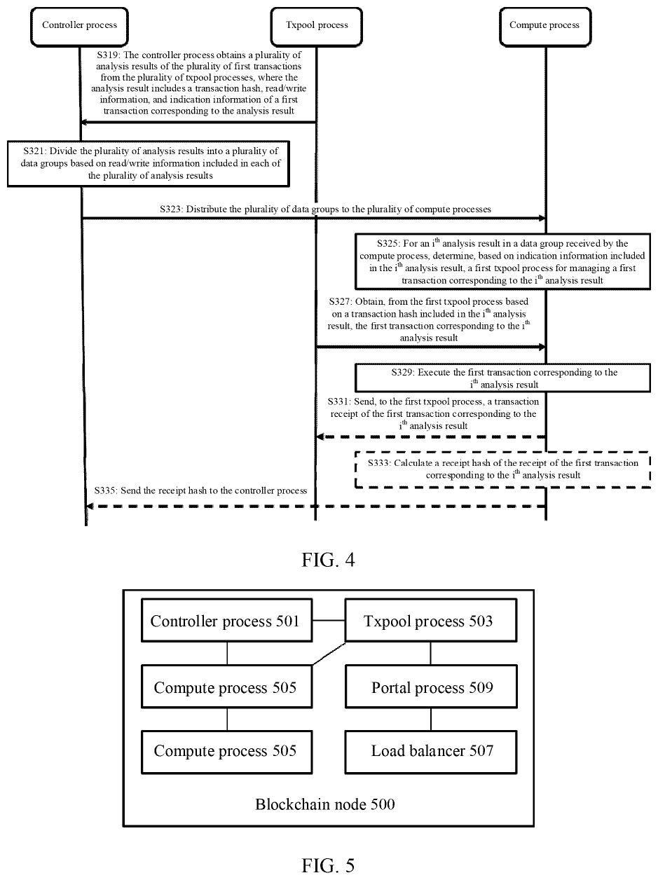

FIG. 4 is a flowchart illustrating a transaction execution method in a blockchain system, according to one or more embodiments of this specification. The method illustrates a process in which the plurality of first transactions are executed through cooperation of the controller process, the plurality of txpool processes, and the plurality of compute processes when the blockchain node reaches a consensus on the consensus proposal based on the plurality of first transactions.

With reference to FIG. 4, the method can include but is not limited to some or all of the following step S319 to step S335.

Step S319: The controller process obtains a plurality of analysis results of the plurality of first transactions from the plurality of txpool processes, where the analysis result includes a transaction hash, read/write information, and indication information of a first transaction corresponding to the analysis result.

After a consensus is reached on the consensus proposal based on the plurality of first transactions, for a transaction hash and indication information of each first transaction in the consensus proposal, the consensus in the controller process can determine, based on the indication information of the first transaction, a third txpool process for managing the first transaction, and send the transaction hash and the indication information of the first transaction to the third txpool process. After receiving the transaction hash and the indication information of the first transaction, the third txpool process can find, through query based on the transaction hash of the first transaction, a plaintext of the first transaction managed by the third txpool process, and then perform post-verification on the first transaction, for example, verification on a signature and a transaction format of the first transaction, and anti-playback detection. The verification on the signature and the transaction format of the first transaction can use a verification result of pre-verification on the first transaction. After the verification succeeds, the third txpool process can obtain read/write information of the first transaction by pre-executing the first transaction or in another analysis way, then combine the transaction hash, the read/write information, and the indication information of the first transaction into an analysis result of the first transaction, and return the analysis result of the first transaction to the controller process.

Read/write information of a single first transaction can include keys of parameters that needs to be read from and written to status data when the first transaction is executed. More specifically, the read/write information of the single first transaction includes, for example, a pre-execution read set and a pre-execution write set.

Next, in step S321, the controller process divides the plurality of analysis results into a plurality of data groups based on read/write information included in each of the plurality of analysis results.

In a process of obtaining the plurality of data groups, it needs to be ensured that first transactions respectively corresponding to any two analysis results in any two data groups do not conflict with each other. That any two first transactions do not conflict with each other specifically means absence of the following cases in the any two first transactions: a pre-execution read set of one first transaction and a pre-execution write set of the other first transaction include the same key, or a pre-execution write set of the one first transaction and the pre-execution write set of the other first transaction include the same key. For any two first transactions in conflict, analysis results of the any two first transactions need to be assigned into the same data group. To be specific, if respective pre-execution write sets of the any two first transactions include the same key, it can be considered that the any two first transactions access the same parameter, leading to a conflict, and the analysis results of the any two first transactions need to be assigned into the same data group. If a pre-execution read set of one of the any two first transactions and a pre-execution write set of the other first transaction include the same key, it can be considered that the any two first transactions access the same parameter, leading to a conflict, and the analysis results of the any two first transactions need to be assigned into the same data group. In some other possible implementations, to efficiently determine group information of the plurality of first transactions or efficiently divide the plurality of analysis results of the plurality of first transactions into a plurality of data groups, the plurality of analysis results of the plurality of first transactions usually can be divided into groups based on a need that first transactions corresponding to any two analysis results in any two different data groups do not access the same parameter (that is, do not include the same key).

Next, in step S323, the controller process distributes the plurality of data groups to the plurality of compute processes.

Different data groups can be distributed to different compute processes. When a quantity of compute processes is small, at least two different data groups may be distributed to the same compute process.

Steps S325: For an i^{th} analysis result in a data group received by the compute process, the compute process determines, based on indication information included in the i^{th} analysis result, a first txpool process for managing a first transaction corresponding to the i^{th} analysis result.

Step S327: The compute process obtains, from the first txpool process based on a transaction hash included in the i^{th} analysis result, the first transaction corresponding to the i^{th} analysis result.

Step S329: The compute process executes the first transaction corresponding to the i^{th} analysis result.

The compute process can traverse the data group received by the compute process, invoke a storage interface/storage process to read values of all keys in read/write information in batches, and then execute, by using a read key-value pair, a first transaction corresponding to each analysis result included in the data group received by the compute process. After each first transaction is executed, an execution write set including the key-value pair corresponding to each first transaction can be obtained, and then the key-value pair in the execution write set is committed by invoking the storage interface.

After a single first transaction is executed, the compute process can further obtain a transaction receipt of the first transaction.

For ease of description, the first transactions corresponding to the analysis results in the data group received by the compute process are described as a tx group below. After executing all the first transaction in the tx group, the compute process can further notify the controller process that the tx group of the compute process currently has been completed, and can further perform the following step S331 to step S335.

Step S331: Send, to the first txpool process, a transaction receipt of the first transaction corresponding to the i^{th} analysis result.

Step S333: Calculate a receipt hash of the receipt of the first transaction corresponding to the i^{th} analysis result.

Step S335: Send the receipt hash to the controller process.

The receipt hash is used to support the controller process in generating a receipt root hash included in a block header of the target block.

The compute process can further invoke the storage interface to store a block slice. The block slice includes the first transactions in the tx group and receipts corresponding to the first transactions, and the block slice is a component of a block body of the target block to be generated.

After the block slice is stored, the compute process can further notify the controller process that the block slice of the tx group currently has been persisted by the compute process. In addition, after all tx groups of the target block are completed, the controller process can invoke a storage interface commit state to obtain a new state root hash State_Root through calculation. After notified that all the tx groups of the target block have block slices stored, the controller process can further invoke a storage interface write state to persist status data. In this case, the controller process can start to calculate the block header (tx root, receipt root) of the current block, and write the block header. Finally, the controller process updates a write block number of the latest generated target block in a metadb, commits and acknowledges a block header hash by using a controller validator module, and notifies the txpool processes of a stable block number. After notified of the stable block number, the txpool processes correspondingly push transaction receipts to related client devices for the first transactions of the target block, that is, invoke the portal processes to return the receipts of the first transactions to the client devices.

Based on the same concept as the method embodiments above, one or more embodiments of this specification further provide a blockchain node 500 in a blockchain system. With reference to FIG. 5, the blockchain node 500 includes a controller process 501, a plurality of txpool processes 503, and a plurality of compute processes 505. The controller process 501 is configured to obtain a plurality of analysis results of a plurality of first transactions from the plurality of txpool processes 503. The analysis result includes a transaction hash, read/write information, and indication information of a first transaction corresponding to the analysis result. The controller process 501 is further configured to divide the plurality of analysis results into a plurality of data groups based on read/write information included in each of the plurality of analysis results, and distribute the plurality of data groups to the plurality of compute processes 505. The compute process 505 is configured to: for an i^{th} analysis result in a data group received by the compute process, determine, based on indication information included in the i^{th} analysis result, a first txpool process for managing a first transaction corresponding to the i^{th} analysis result, obtain, from the first txpool process based on a transaction hash included in the i^{th} analysis result, the first transaction corresponding to the i^{th} analysis result, and execute the first transaction corresponding to the i^{th} analysis result.

In some possible implementations, the controller process 501 is further configured to receive transaction hashes and indication information of the plurality of first transactions from the plurality of txpool processes; the controller process 501 is further configured to generate a consensus proposal including the transaction hashes and the indication information of the plurality of first transactions; and the controller process 501 is further configured to perform a consensus on the consensus proposal.

In some possible implementations, the txpool process 503 is further configured to receive a second transaction, where the second transaction belongs to the plurality of first transactions; and the txpool process 503 is further configured to obtain indication information of the second transaction based on the second transaction, calculate a transaction hash of the second transaction, and send the transaction hash and the indication information of the second transaction to the controller process 501.

In some possible implementations, the blockchain node 500 further includes a first portal process. The first portal process is configured to obtain the indication information of the second transaction based on the second transaction, determine, from the plurality of txpool processes 503 based on the indication information of the second transaction, a second txpool process for managing the second transaction, and send the second transaction to the second txpool process.

In some possible implementations, the blockchain node 500 further includes a load balancer 507 and a plurality of portal processes 509, and the plurality of portal processes 509 include the first portal process. The load balancer 507 is configured to receive the second transaction from a client device. The load balancer 507 is further configured to select the first portal process from the plurality of portal processes, and send the second transaction to the first portal process 509.

In some possible implementations, the second txpool process is configured to send the second transaction to a remaining blockchain node in the blockchain system.

In some possible implementations, the compute process 505 is further configured to send, to the first txpool process, a transaction receipt of the first transaction corresponding to the i^{th} analysis result; and the compute process 505 is further configured to calculate a receipt hash of the receipt of the first transaction corresponding to the i^{th} analysis result, and send the receipt hash to the controller process 501.

In some possible implementations, the indication information of the first transaction includes an account that initiates the first transaction, or the indication information of the first transaction is obtained through processing based on the account that initiates the first transaction.

One or more embodiments of this specification further provide a computer-readable storage medium, storing a computer program/instructions. When the computer program/instructions are executed in a computer, the computer is enabled to perform the method steps performed by a blockchain node in a blockchain system in any one of the method embodiments above.

One or more embodiments of this specification further provide a computing device, including a memory and a processor. The memory stores executable code/instructions, and when the processor executes the executable code/instructions, the method steps performed by a blockchain node in a blockchain system in any one of the method embodiments above are implemented.

In the 1990s, whether a technical improvement is a hardware improvement (for example, an improvement to a circuit structure such as a diode, a transistor, or a switch) or a software improvement (an improvement to a method flow) can be clearly distinguished. However, with the development of technology, improvements of many method flows can be considered as direct improvements to hardware circuit structures. Designers almost all obtain corresponding hardware circuit structures by programming improved method procedures into hardware circuits. Therefore, it cannot be said that an improvement to a method flow cannot be implemented using a hardware entity module. For example, a programmable logic device (PLD), such as a field programmable gate array (FPGA), is such an integrated circuit whose logic functions are determined by a user programming the device. A designer can perform programming autonomously to “integrate” a digital system onto a PLD, instead of asking a chip manufacturer to design or produce a dedicated integrated circuit chip. Moreover, nowadays, instead of manually making an integrated circuit chip, such programming is mostly implemented using “logic compiler” software, which is similar to a software compiler used when a program is developed, and original code before compilation needs to be written in a specific programming language, which is referred to as a hardware description language (HDL). There is not just one HDL, but are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The Very-High-Speed Integrated Circuit Hardware Description Language (VHDL) and Verilog are the most commonly used currently. A person skilled in the art should also understand that as long as a method flow is logically programmed and then programmed into an integrated circuit by using the hardware description languages, a hardware circuit that implements the logical method flow can be easily obtained.

A controller can be implemented in any appropriate way. For example, the controller can be in the form of, for example, a microprocessor or processor and a computer-readable medium storing computer-readable program code (for example, software or firmware) that can be executed by the (micro) processor, a logic gate, a switch, an application specific integrated circuit (ASIC), a programmable logic controller, or an embedded microcontroller. Examples of the controller include but are not limited to the following microcontrollers: ARC 625D, Atmel AT91SAM, Microchip PIC18F26K20, or Silicone Labs C8051F320. A memory controller can also be implemented as a part of a memory control logic. A person skilled in the art will also appreciate that, in addition to implementing the controller in the form of pure computer-readable program code, it is also possible to logically program the method steps so that the controller implements the same function in the form of a logic gate, a switch, an application specific integrated circuit, a programmable logic controller, an embedded microcontroller, or the like. Therefore, this controller can be considered as a hardware component, and an apparatus included therein for implementing various functions can be considered as a structure in the hardware component. Or the apparatus for implementing various functions can even be considered as both a software module for implementing a method and the structure in the hardware component.

The system, apparatus, module, or unit stated in the embodiments above can specifically be implemented using a computer chip or entity, or may be implemented by a product having a specific function. A typical implementing device is a server system. Certainly, this application does not exclude that with the development of computer technology in the future, the computer that implements the functions in the embodiments above may be, for example, a personal computer, a laptop computer, a vehicular human-computer interaction device, a cellular phone, a camera phone, a smart phone, a personal digital assistant, a media player, a navigation device, an E-mail device, a game console, a tablet computer, a wearable device, or a combination of any of these devices.

Although one or more embodiments of this specification provide method operation steps as described in the embodiments or the flowcharts, more or fewer operation steps may be included based on conventional or non-creative means. A sequence of steps listed in the embodiments is merely one of various step execution sequences and does not represent the only execution sequence. When executed in an actual apparatus or end product, the steps can be executed sequentially or in parallel in accordance with the method sequence shown in the embodiments or the accompanying drawings (for example, in a parallel processor or multithreaded processing environment, or even a distributed data processing environment). The term “include”, “comprise”, or any other variant thereof is intended to cover non-exclusive inclusion, so that a process, method, product, or device including a series of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, and the like are used for indicating names, they do not indicate any particular order.

For ease of description, the above-mentioned apparatuses are divided into various modules based on functions for respective descriptions. Certainly, during implementation of one or more embodiments of this specification, the functions of the modules can be implemented in one or more pieces of software and/or hardware, or modules implementing the same function can be implemented using a combination of a plurality of sub-modules or sub-units, or the like. The apparatus embodiments described above are merely examples. For example, division into the units is merely logical function division and there can be other division ways in practice. For example, a plurality of units or components can be combined or integrated into another system, or some features may be ignored or not performed. In addition, the displayed or discussed mutual couplings or direct couplings or communication connections can be implemented using some interfaces. The indirect couplings or communication connections between the apparatuses or units can be implemented in electronic, mechanical, or other forms.

This application is described with reference to the flowchart and/or block charts of methods, apparatuses (systems), and computer program products according to the embodiments of this application. It should be understood that each process and/or box in a flowchart and/or block chart, and combinations of processes and/or boxes in the flowchart and/or block chart, can be implemented using computer program instructions. These computer program instructions can be provided to a processor of a general-purpose computer, a special-purpose computer, an embedded processor, or other programmable data processing devices, to produce a machine, so that the instructions executed by the processor of the computer or other programmable data processing devices generate an apparatus for implementing functions specified in one or more processes of a flowchart and/or one or more boxes of a block chart.

These computer program instructions can also be stored in a computer-readable memory that can guide a computer or another programmable data processing device to operate in a particular way, so that the instructions stored in the computer-readable memory produce an article of manufacture including an instruction apparatus, and the instruction apparatus implements the functions specified in the one or more processes of the flowchart and/or the one or more boxes of the block chart.

These computer program instructions can also be loaded to the computer or another programmable data processing device, so that a series of operation steps are executed on the computer or another programmable data processing device, to produce processing implemented by the computer, and therefore, the instructions executed on the computer or another programmable data processing device provide steps of implementing the functions specified in the one or more processes of the flowchart and/or the one or more boxes of the block chart.

In a typical configuration, a computing device includes one or more processors (CPUs), an input/output interface, a network interface, and a memory.

The memory can include a form of a volatile memory, a random access memory (RAM) and/or a non-volatile memory, and the like in a computer-readable medium, such as a read-only memory (ROM) or a flash memory (flash RAM). The memory is an example of the computer-readable medium.

The computer-readable medium includes non-volatile and volatile media as well as removable and non-removable media, and can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. As defined here, the computer-readable medium does not include transitory media, such as modulated data signals and carriers.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, or the like) that include computer-usable program code.

The one or more embodiments of this specification can be described in the general context of computer-executable instructions executed by a computer, for example, a program module. Usually, the program module includes a routine, a program, an object, a component, a data structure, or the like for executing a specific task or implementing a specific abstract data type. One or more embodiments of this specification can also be practiced in distributed computing environments where tasks are performed by remote processing devices that are connected through a communication network. In the distributed computing environment, a program module can be located in local and remote computer storage media including a storage device.

The embodiments of this specification are all described in a progressive way. For same or similar parts in the embodiments, mutual references can be made to the embodiments. Each embodiment focuses on a difference from other embodiments. In particular, the system embodiments are basically similar to the method embodiments, and therefore are briefly described. For related parts, references can be made to the descriptions in the method embodiments. In the descriptions of this specification, references to the term “one embodiment”, “some embodiments”, “examples”, “specific examples”, or “some examples” mean that specific features, structures, materials, or characteristics described in conjunction with this embodiment or example are included in at least one embodiment or example of this specification. In this specification, the illustrative descriptions of the terms do not necessarily refer to the same embodiment or example. Moreover, the specific features, structures, materials, or characteristics described can be combined in any one or more embodiments or examples in an appropriate way. In addition, a person skilled in the art can combine and associate different embodiments or examples and features of the different embodiments or examples described in this specification, provided that the embodiments or examples and the features do not conflict with each other.

What is described above is merely one or more embodiments of this specification, and is not intended to limit the one or more embodiments of this specification. A person skilled in the art can make various changes and variations to the one or more embodiments of this specification. Any modifications, equivalent replacements, improvements, or the like made without departing from the spirit and principle of this specification shall fall within the scope of the claims.

1. A transaction execution method, comprising:
obtaining, by a controller process of a blockchain node, a plurality of analysis results of a plurality of transactions from a plurality of txpool processes of the blockchain node, wherein each of the plurality of analysis result comprises a transaction hash, read/write information, and indication information of a first transaction in the plurality of transactions corresponding to the analysis result;
dividing, by the controller process, the plurality of analysis results into a plurality of data groups based on read/write information comprised in each of the plurality of analysis results, and distributing the plurality of data groups to a plurality of compute processes in the blockchain node; and
for an i^{th} analysis result in a data group received by a corresponding compute process:
determining, by the compute process based on indication information comprised in the i^{th} analysis result, a first txpool process in the plurality of txpool processes for managing a first transaction corresponding to the i^{th} analysis result;
obtaining, from the first txpool process in the plurality of txpool processes based on a transaction hash comprised in the i^{th} analysis result, the first transaction corresponding to the i^{th} analysis result; and
executing the first transaction corresponding to the i^{th} analysis result.

2. The method according to claim 1, wherein the method further comprises:
receiving, by the controller process, transaction hashes and indication information of the plurality of transactions from the plurality of txpool processes;
generating, by the controller process, a consensus proposal comprising the transaction hashes and the indication information of the plurality of transactions; and
performing, by the controller process, a consensus on the consensus proposal.

3. The method according to claim 1, wherein the method further comprises:
receiving, by the first txpool process, a second transaction in the plurality of transactions;
obtaining, by the first txpool process based on the second transaction, indication information of the second transaction;
calculating a transaction hash of the second transaction; and
sending the transaction hash and the indication information of the second transaction to the controller process.

4. The method according to claim 3, wherein the blockchain node further comprises a first portal process, and wherein the method further comprises:
obtaining, by the first portal process, the indication information of the second transaction based on the second transaction;
determining, from the plurality of txpool processes based on the indication information of the second transaction, a second txpool process in the plurality of txpool processes for managing the second transaction; and
sending the second transaction to the second txpool process.

5. The method according to claim 4, wherein the blockchain node further comprises a load balancer and a plurality of portal processes, and the plurality of portal processes comprise the first portal process, and wherein the method further comprises:
receiving, by the load balancer, the second transaction from a client device;
selecting, by the load balancer, the first portal process from the plurality of portal processes; and
sending the second transaction to the first portal process.

6. The method according to claim 4, wherein the method further comprises:
sending, by the second txpool process, the second transaction to another blockchain node in a same blockchain system.

7. The method according to claim 1, wherein the method further comprises:
sending, by the compute process to the first txpool process, a transaction receipt of the first transaction corresponding to the i^{th} analysis result; and
calculating, by the compute process, a receipt hash of the receipt of the first transaction corresponding to the i^{th} analysis result, and sending the receipt hash to the controller process.

8. The method according to any one of claim 1, wherein:
the indication information of the first transaction comprises an account that initiates the first transaction; or
the indication information of the first transaction is obtained through processing based on the account that initiates the first transaction.

9. A blockchain node comprising:
at least one processor; and
one or more memories coupled to the at least one processor and storing programming instructions for execution by the at least one processor to:
perform a controller process of the blockchain node to:
obtain a plurality of analysis results of a plurality of transactions from a plurality of txpool processes of the blockchain node, wherein each of the plurality of analysis results comprises a transaction hash, read/write information, and indication information of a first transaction in the plurality of transactions corresponding to the analysis result;
divide the plurality of analysis results into a plurality of data groups based on read/write information comprised in each of the plurality of analysis results;
distribute the plurality of data groups to the plurality of compute processes of the blockchain node; and
for an i^{th} analysis result in a data group received by the compute process:
determine, based on indication information comprised in the i^{th} analysis result, a first txpool process in the plurality of txpool processes for managing a first transaction corresponding to the i^{th} analysis result;
obtain, from the first txpool process based on a transaction hash comprised in the i^{th} analysis result, the first transaction corresponding to the i^{th} analysis result; and
execute the first transaction corresponding to the i^{th} analysis result.

10. The blockchain node according to claim 9, wherein the programming instructions are for execution by the at least one processor to perform the controller process to:
receive transaction hashes and indication information of the plurality of transactions from the plurality of txpool processes;
generate a consensus proposal comprising the transaction hashes and the indication information of the plurality of transactions; and
perform a consensus on the consensus proposal.

11. The blockchain node according to claim 9, wherein the first txpool process is configured to:
receive a second transaction, wherein the second transaction belongs to the plurality of transactions;
obtain, based on the second transaction, indication information of the second transaction;
calculate a transaction hash of the second transaction; and
send the transaction hash and the indication information of the second transaction to the controller process.

12. The blockchain node according to claim 11, wherein the programming instructions are for execution by the at least one processor to:
perform a first portal process to:
obtain the indication information of the second transaction based on the second transaction;
determine, from the plurality of txpool processes based on the indication information of the second transaction, a second txpool process for managing the second transaction; and
send the second transaction to the second txpool process.

13. The blockchain node according to claim 12, wherein the programming instructions are for execution by the at least one processor to:
cause a load balancer of the blockchain node to receive the second transaction from a client device;
select the first portal process from a plurality of portal processes that comprise the first portal process; and
send the second transaction to the first portal process.

14. The blockchain node according to claim 12, wherein the second txpool process is configured to send the second transaction to another blockchain node in a same blockchain system.

15. The blockchain node according to claim 9, wherein the programming instructions are for execution by the at least one processor to perform the controller process to:
send, to the first txpool process, a transaction receipt of the first transaction corresponding to the i^{th} analysis result;
calculate a receipt hash of the receipt of the first transaction corresponding to the i^{th} analysis result; and
send the receipt hash to the controller process.

16. The blockchain node according to claim 9, wherein the indication information of the first transaction comprises an account that initiates the first transaction, or the indication information of the first transaction is obtained through processing based on the account that initiates the first transaction.

17. A non-transitory, computer-readable medium storing one or more instructions executable by at least one processor to perform operations comprising:
obtaining, by a controller process of a blockchain node, a plurality of analysis results of a plurality of transactions from a plurality of txpool processes of the blockchain node, wherein each of the plurality of analysis results comprises a transaction hash, read/write information, and indication information of a first transaction in the plurality of transactions corresponding to the analysis result;
dividing, by the controller process, the plurality of analysis results into a plurality of data groups based on read/write information comprised in each of the plurality of analysis results, and distributing the plurality of data groups to a plurality of compute processes in the blockchain node; and
for an i^{th} analysis result in a data group received by a corresponding compute process:
determining, by the compute process based on indication information comprised in the i^{th} analysis result, a first txpool process in the plurality of txpool processes for managing a first transaction corresponding to the i^{th} analysis result;
obtaining, from the first txpool process in the plurality of txpool processes based on a transaction hash comprised in the i^{th} analysis result, the first transaction corresponding to the i^{th} analysis result; and
executing the first transaction corresponding to the i^{th} analysis result.

18. The non-transitory, computer-readable medium according to claim 17, wherein the operations further comprise:
receiving, by the controller process, transaction hashes and indication information of the plurality of transactions from the plurality of txpool processes;
generating, by the controller process, a consensus proposal comprising the transaction hashes and the indication information of the plurality of transactions; and
performing, by the controller process, a consensus on the consensus proposal.

19. The non-transitory, computer-readable medium according to claim 17, wherein the operations further comprise:
receiving, by the first txpool process, a second transaction in the plurality of transactions;
obtaining, by the first txpool process based on the second transaction, indication information of the second transaction;
calculating a transaction hash of the second transaction; and
sending the transaction hash and the indication information of the second transaction to the controller process.

20. The non-transitory, computer-readable medium according to claim 19, wherein the blockchain node further comprises a first portal process, and wherein the operations further comprise:
obtaining, by the first portal process, the indication information of the second transaction based on the second transaction;
determining, from the plurality of txpool processes based on the indication information of the second transaction, a second txpool process in the plurality of txpool processes for managing the second transaction; and
sending the second transaction to the second txpool process.
